(19) United States
(12) Patent Application Publication
(10) Pub. No.: US 2003/0174586 A1
(43) Pub. Date: Sep. 18, 2003

(54) Clocks with diffusion reflector lighting

(76) Inventors: Patrick Fong Wing Hon, Sunshine City (HK); Keith E. Kibiloski, Virginia Beach, VA (US); So Si Kin, Hong Kong (HK); Charles Wong Tak Chung, Hong Kong (HK)

Correspondence Address: Cook, Alex, McFarron, Manzo, Cummings, & Mehler, Suite 2850, 200 West Adams, Chicago, IL, 60606, US

(21) Appl. No.: 10/304,329

(22) Filed: Nov. 26, 2002

Related U.S. Application Data
(60) Provisional application No. 60/334,428, filed on Nov. 30, 2001.

(51) Int. Cl. G04C 19/00

(52) U.S. Cl. 368/84

(57) ABSTRACT

A clock with a display of the liquid crystal display (LCD) type provides indicia such as time, day, month, year and temperature, and also provides sufficient back lighting to operate as a night light. The clock has a reflector module disposed behind the LCD display with a generally clear module element that may have an engraved back surface for improved light dispersion from one or more light sources, such as light emitting diodes (LEDs). The module element has edges with reflective properties, a light reflective material disposed behind said module element and one or more light sources disposed along an edge thereof. The edge of the module element preferably has a notch or recess for positioning the light source therein. The invention also includes reflector modules for clocks.

### BACKGROUND OF THE INVENTION

This invention generally relates to clocks having multiple features including unique lighting and display features. More particularly, a preferred embodiment of the invention relates to clocks incorporating a liquid crystal display (LCD) that may be associated with a night light feature, typically including a timing arrangement for night light illumination. Often, these features can be combined with temperature display capabilities, alarm time display capabilities, multiple color display capabilities and/or automatic color and/or light variation capabilities. The present invention also relates to improved reflector modules for back lighting of LCD displays.

### FIELD OF THE INVENTION

Clocks having numerous types of lighting and functioning features have been proposed and developed. Often clocks have an illumination characteristic, often provided solely for the purpose of enabling the user to read the time without the assistance of other illumination sources. Occasionally, devices combining time piece and night light properties have been proposed. Examples include Chaien U.S. Pat. No. 5,926,440 and Chaien U.S. Pat. Application Publication No. 2001/0033481. The approach shown in Chaien incorporates electro-luminescent technology, which has limited capabilities.

Other approaches propose combining time and temperature functions in a single device. Included is Reap U.S. Pat. No. 4,451,157 that uses liquid crystals to indicate the time by observing hour and minute hands and indicate the temperature by observing color change to liquid crystal markings. Koike U.S. Pat. No. 4,044,546 proposes digital liquid crystal electronic time pieces having a display which is color coded to help differentiate between seconds, minutes, hours, dates and months. Havel U.S. Pat. No. 4,702,615 provides a variable color display on a time piece so as to provide an analog indication of time by color changes on an analog face.

Clock technology of this type provides limited functionality and does not offer feature combinations which allow for multiple functions including a night light function which is of controlled duration and allows for superior diffusion reflector lighting and visual variations while retaining enough light intensity to perform well as night lights.

An avenue of technology that has progressed is the development of liquid crystal display devices. Reflective surfaces are important in these types of devices. Kimura U.S. Pat. No. 5,610,741 shows a reflection type LCD display having a reflective surface with protruding components. Light originates generally from outside of the LCD.

Quo U.S. Pat. No. 5,714,247 shows liquid crystal devices that can include multiple light emitting diode (LED) sources, which are directed substantially head-on onto a reflective layer having an array of convex pedestals to provide a non-specular, reflecting surface. Tsuda U.S. Pat. No. 5,936,688 shows multiple light sources such as LED sources directed onto the face of a reflector surface. Hayashi U.S. Pat. No. 6,166,793 proposes reflective LCD and light diffusion using an angularly selective light diffuser directly onto the LCD display.

Each of the patents identified herein is incorporated by reference hereinto.

There is a need for advantageous night light capabilities that can be provided by incorporating liquid crystal display technology with improved reflector modules for back lighting of the LCD display, including in combination with clocks having a variety of features or functions. This is made economically feasible and viable by incorporating features according to the invention.

### SUMMARY OF THE INVENTION

The present invention has several aspects and options. Included in the options are the following. A clock has a night light that can be programmed to automatically illuminate and shut down at designated times. Another such feature is providing a temperature display and/or providing an alarm time display. The night light preferably incorporates a liquid crystal display (LCD) having specific components and layers including a perimeter edge. One or more light sources provide illumination into a reflector module at one or more locations along the perimeter edge.

The clock of the present invention has a reflector module disposed behind the LCD display to provide back lighting for the LCD display and to provide sufficient illumination therethrough to operate as a night light. The reflector module is generally of the same or larger area as the LCD display. A module element of the reflector module is generally transparent and has light reflective properties along its edges. A reflective material may be disposed behind the module element to enhance the light transmitting and diffusing properties of the reflector module. A portion of the module element may extend beyond the defined area of the LCD display, and those sides of that portion may also have light reflecting properties. One or more LEDs may be positioned along an edged of the module element to provide illumination into the reflector module, such as in a notch or recess. When a plurality of LEDs is utilized, at least two of the LEDs may be of different colors for lighting effects.

For improved light dispersion, the module element may be engraved on its back surface with dot patterns or the like. A diffusion layer may be interposed between the LCD display and the reflector element to improve the light dispersion through the LCD display. Multiple reflector modules may be used with multiple LCD displays for enhanced effects.

A general object of the present invention to provide an improved clock that has a night light feature.

Another object of this invention is to provide an improved clock providing multi-color display features.

Yet another object of the present invention is to provide improved clock structures that provide time, date and day of the week displays.

A further object of the present invention is to provide improved clock structures incorporating temperature display capability.

A still further object of this invention is to provide an improved clock that provides multi-colored displays in accordance with different functions available on the device.

Another object of the invention is to provide an improved clock having an LCD display in combination with an improved reflector modules for back lighting of the display that also operates as a night light.

Still another object of the present invention is to provide an improved clock with an LCD display in combination with an improved reflector module that may be powered from a variety of power sources, including conventional batteries, rechargeable batteries, solar cells and AC power.

Yet another object of the present invention is to provide improved reflector modules for back lighting of LCD displays.

A further object of the present invention is to provide improved reflector modules that have one or more edge-positioned light sources.

These and other objects, features and advantages of the present invention will more clearly be understood through a consideration of the following detailed description.

### BRIEF DESCRIPTION OF THE DRAWINGS

In the course of this description, reference will be made to the attached drawing Figures, wherein like reference numerals will refer to like elements in the various Figures, and wherein:

FIG. 1 is a perspective view of a clock and night light combination according to the invention;

FIG. 2 is an elevational view of the clock of FIG. 1;

FIG. 3 is an elevational rear view typical of a clock such as shown in FIG. 1;

FIG. 4 is a data flow chart illustrating typical operational modes for a clock such as shown in FIGS. 1-3;

FIG. 5 is a schematic of operational circuitry suitable for the clock shown in FIGS. 1-3 that operates from conventional batteries;

FIG. 5A is a schematic of the operational circuitry suitable for the clock shown in FIGS. 1-3 that operates from a rechargeable battery and/or solar cells;

FIG. 5B is a schematic of the operational circuitry suitable for the clock shown in FIGS. 1-3 that operates from a rechargeable battery and/or AC power;

FIG. 6 is an elevational view of a back lighting module for a liquid crystal display, such as for the clock shown in FIGS. 1-3;

FIG. 7 is an end elevational view of the back lighting module shown in FIG. 6, depicting the edge orientation of this assembly;

FIG. 8 is an enlarged, detail view of a portion of the back lighting module shown in FIG. 6;

FIG. 9 is an elevational view of the rear face of the back lighting module shown in FIG. 6;

FIG. 10 is an enlarged, detail view of a portion of the back lighting module shown in FIG. 9;

FIG. 11 is an elevational view of a first alternate embodiment of the diffusion reflector module shown in FIGS. 6-10 incorporating an LED light source, which reflector module can be incorporated into a clock such as the clock shown in FIGS. 1-3;

FIG. 12 is an exploded end view of the first alternate embodiment of the diffusion reflector module of FIG. 11;

FIG. 13 is an enlarged, detail view of a portion of the reflector module shown in FIGS. 11-12;

FIG. 14 is an elevational view of a second alternate embodiment of the diffusion reflector module illustrating light transmission and reflection within the diffusion reflector module that can be incorporated into the clock shown in FIGS. 1-3;

FIG. 15 is an end view of the diffusion reflector module of FIG. 14;

FIG. 16 is an illustration of a fourth alternate embodiment for a back lighting module incorporating multiple LED units and multiple coloration options suitable for the clock shown in FIGS. 1-3;

FIG. 17 is an illustration of a fifth alternate embodiment for a back lighting module incorporating multi-colored LED sources and suitable for use in the clock shown in FIGS. 1-3;

FIG. 18 is an elevational view of a sixth alternate embodiment of a back lighting module with a side mounted light source for the clock shown in FIGS. 1-3;

FIG. 19 is an end elevational view of the back lighting module shown in FIG. 18;

FIG. 20 is a front elevational view of a seventh alternate embodiment of a back lighting module with LEDs positioned in yet another location for the clocks shown in FIGS. 1-3;

FIG. 21 is an end elevational view of the back lighting module shown in FIG. 20;

FIG. 22 is a top plan view of the back lighting module shown in FIGS. 20 and 21;

FIG. 23 is a front elevational view of a eighth alternate embodiment of a back lighting module with three LEDs positioned in one corner of the module to provide at least three different colors of back lighting;

FIG. 24 is a front elevational view of a ninth alternate embodiment of a back lighting module with two LEDs, one LED positioned in each of opposite corners of the module, to provide the same color or two colors of back lighting;

FIG. 25 is a front elevational view of a tenth alternate embodiment of a back lighting module with a single LED, similar to the embodiment shown in FIG. 9, but with the LED positioned at an opposite corner of the module; and

FIG. 26 is an exploded end view of another embodiment of the reflector module shown in FIG. 12.

### DESCRIPTION OF THE PREFERRED EMBODIMENTS

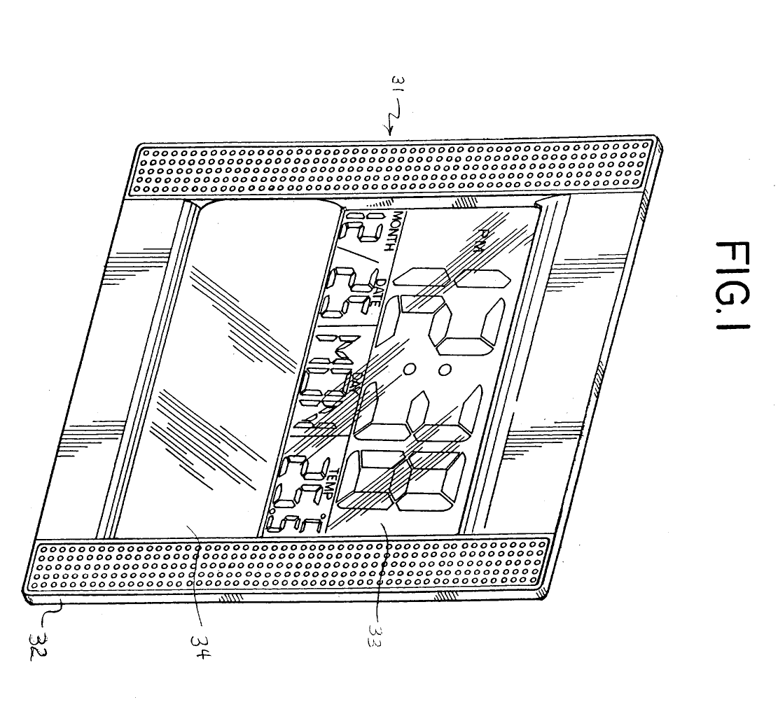

An illustration of a clock in accordance with the present invention is shown in FIG. 1. This embodiment of the clock is generally designated by reference numeral 31. Included is a casing 32 that can take on any desired shape including the particular ornamental embodiment illustrated in FIG. 1. Functionally, this embodiment includes a display location 33 that provides a convenient arrangement of informational indicia discussed herein in greater detail. A lighting location 34 may also be provided. This can take on any variety of shapes and sizes, depending upon the particular design and/or requirements of the clock and casing.

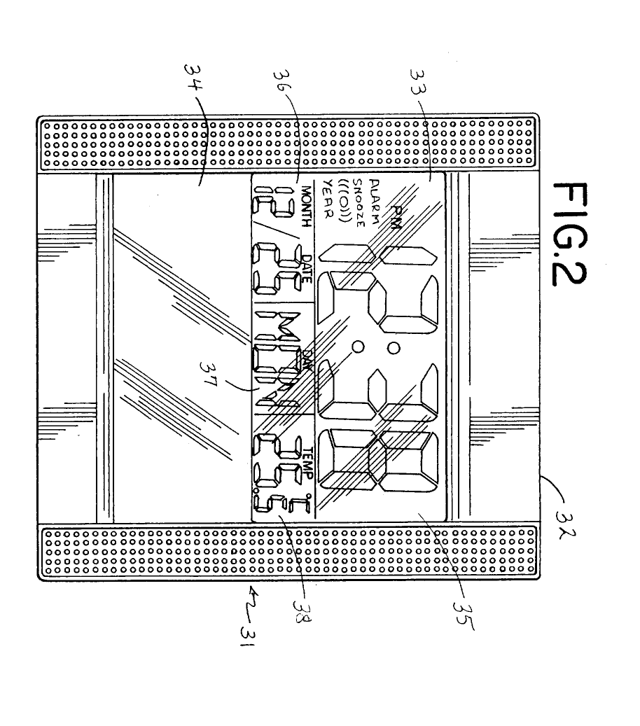

Generally, and as illustrated in this particular embodiment, including in FIG. 2, the display location 33 can be divided into different specific display areas. In this illustration, these include a time area 35, a date area 36, a day of the week area 37, and a temperature area 38. The display location also can include indicia which report the year, and indicia which appear when the alarm is armed and when a “snooze” capability is in effect, for example. Such could appear, as desired, within the time area 35, for example.

At least one liquid crystal display (LCD) assembly is provided on the clock. Typically this will be on the front face, although other options are possible depending upon clock structure and design. An LCD assembly can be present at the display location, at the lighting location, or elsewhere as desired. Specifics of the LCD assembly are discussed in greater detail herein.

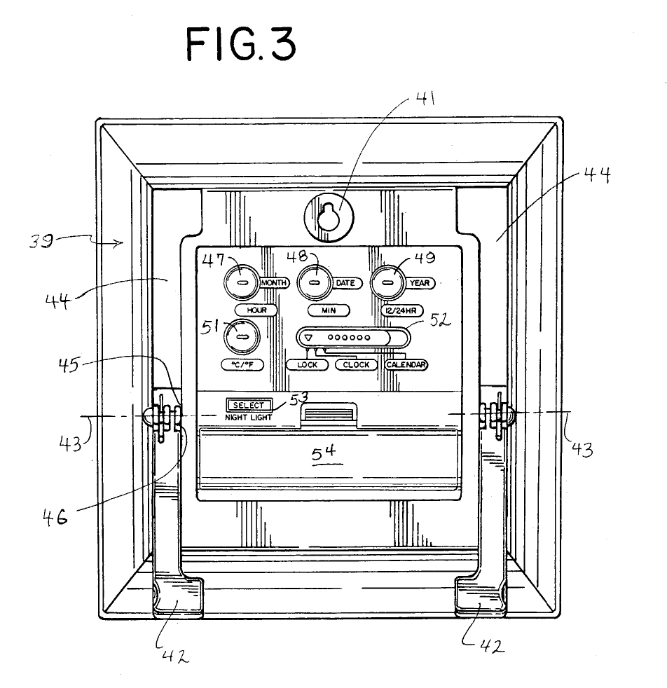

FIG. 3 shows typical features that can be provided on the rear portion of the clock, generally designated as 39. Included on rear portion 39 is a hanger receptacle 41 provided to facilitate suspension of the clock from a wall or other generally vertical surface.

One or more retractable legs 42 also can be provided to facilitate support for the clock on a generally horizontal surface. Various retraction mechanisms or means can be provided. In this illustrated embodiment, each leg pivots along an axis 43 between a closed position at which each leg rests in area 44 and an open position. Typically, this closed position would be the leg position when the clock is suspended from the hanger receptacle 41. The other position or open position of each leg 42 is as shown in FIG. 3. When in this open or extended position, the leg rests at an acute angle with respect to the rear portion 39.

Each leg can be designed to provide a nesting means for maintaining the leg in either the open orientation or the closed orientation. This can be achieved by suitable engagement surfaces on respective portions of the rear 39 of the clock casing. An exemplary engagement surface can be as at 45. Another can be at an opposing portion of the proximal end portion of the leg, such as at 46.

With further reference to the rear portion 39, control features are found thereat in the embodiment shown in FIG. 3. In this particular illustrated embodiment, six key user interface components, such as buttons switches, touch pads and the like, are shown. Included are a hour/month control 47, a minute/date control 48, a time system/year control 49, a Celsius/Fahrenheit control 51, a mode selection control 52, and a select/night light control 53. A compartment 54 accommodates a suitable DC power source, such as batteries when provided.

Control 47, when activated, will change the month or the hour which is displayed at display location 33, depending upon the mode at which the clock is set. Control 48, when activated, changes the date or the minute provided at the display location, in accordance with the mode selected. Control 49 is provided to change the displayed year or setting of the clock format which appears in the display. Control 51 functions as a toggle temperature display unit to select the temperature display in Celsius or Fahrenheit degrees.

Illustrated control 52 is shown as a slide switch for mode selection. Four selections are preferred, including calendar set, alarm set (not shown), clock set, and clock lock. Either on control 52 or on a separate control (not shown), alarm enabling and disabling functions preferably are provided. Such a control has three positions, namely snooze on, alarm on and alarm off.

Concerning the clock component of the device, various clock mechanisms can be used. These include a an LCD display for clock 31. Another option is a clock that has a radio-controlled time capability, such as a so-called atomic clock.

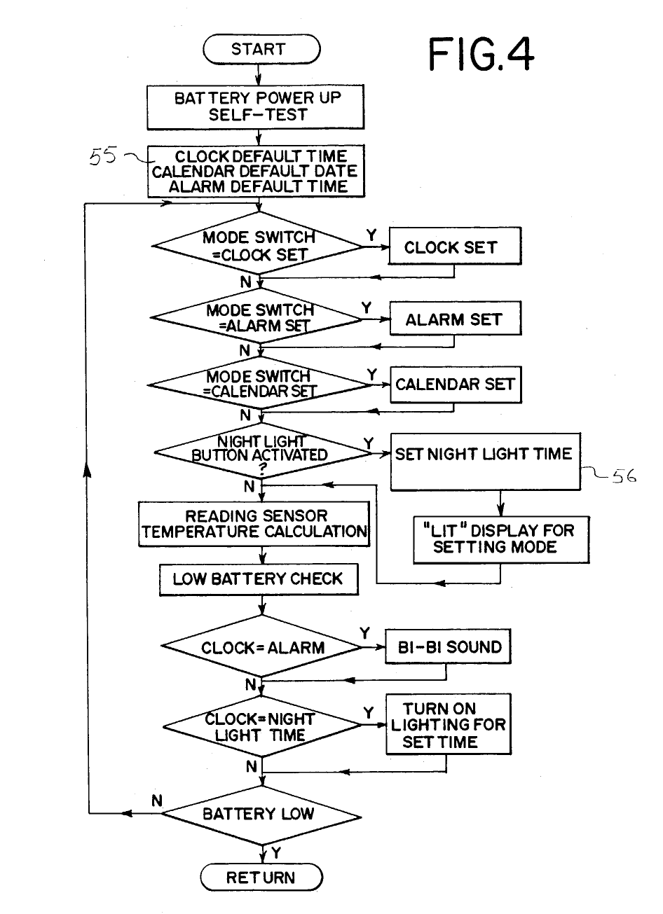

Turning now to FIG. 4, a typical data flow or operational arrangement is shown for a clock according to the invention. Typical default readings that are indicated at default box 55 are preselected. The clock default time can be 12:00 a.m. The calendar default date can be Jan. 1, 2001, and the alarm default time can be 12:00 a.m. for example.

The setting functions are generally illustrated in FIG. 4. Typically, the night light time is set by activating the night light control (e.g. button) when it is pressed for a designated amount of time, such as two seconds. This is indicated at data box 56 and allows the user to set the night light time as desired.

In an exemplary embodiment, one could set a night light time of 10:00 p.m., 11:00 p.m., 12:00 a.m. or none. In this embodiment, this designates the time at which the night light function(s) of the clock will begin illumination. One can provide means so that the user also can set the time when the night light illumination function(s) will cease. In an illustrated embodiment, this time for ceasing is automatically programmed. For example, the user could select the night light to cease seven hours after the night light illumination time setting. In this instance, choosing the 12:00 a.m. setting illuminates the night light function(s) between midnight and 7:00 a.m.

The day of the week determination is made automatically. A suitable calendar look-up table achieves this. Thus, the correct day is displayed to correspond to the month, date and year to which the clock is set. A typical calendar in this regard may span dates from year 2000 to year 2040. Activating the “mode” control to the “calendar” position displays he year and enables the calendar setting selection. In a typical arrangement, the year, month and date digits start to flash. The user presses the appropriate control to adjust year, month and date respectively, and the day of the week is then automatically displayed.

As an example of a suitable scheme for calculation of the day of the week, the following is provided.

Year=Current Year−Current Year

$$\begin{matrix}Day of Week = [ Year + \frac{Year}{4} + Date + f ( Month ) + (* ) ] \%7 \\ (* ) = 1 , ( Current year = Leapyear ) \& 3 ) \\ 0 , otherwise \end{matrix}$$

where Reference Year is the year after a leap year, % 7 means taking the remainder of dividing by 7,

| Day of Week | Sunday | Monday | Tuesday | Wednesday | Thursday | Friday | Saturday |
|---|---|---|---|---|---|---|---|
| Remainder | 0 | 1 | 2 | 3 | 4 | 5 | 6 |

ƒ (Month) = Day of week of the 1^{st} of the Month in the
Reference year-1 For example, if Reference year is 2001
(after leap year 2000),

| | |
|---|---|
| Month | ƒ (Month) |

| | |
|---|---|
| 1 | 0 |
| 2 | 3 |
| 3 | 3 |
| 4 | 6 |
| 5 | 1 |
| 6 | 4 |
| 7 | 6 |
| 8 | 2 |
| 9 | 5 |
| 10 | 0 |
| 11 | 3 |
| 12 | 5 |

With further reference to the function of the invention, a 1.5 volts operating voltage is typical and can be supplied by two AA batteries, by rechargeable batteries, by solar cells and/or by AC power, as is presented in further detail below. Upon initially engaging the power, all LCD segments briefly turn on; such as for a second, and the clock, calendar and temperature displays are energized. Having the mode control at a “clock lock” setting displays the, time month, date, day of the week and temperature on the LCD display. Pressing and holding hour or minute controls can display a daily alarm time.

Time setting is achieved by having the mode control at the “time set” position, after which the clock begins flashing. Activation of the hour or minute controls will implement respective digits in a manner generally known in the art.

Setting of the alarm is achieved with the mode control positioned at the “alarm set” position. Alarm hour digits and minute digits are then displayed and begin to flash. The setting procedure is accomplished in the same manner in the clock setting. Positioning the alarm control at either a “snooze” or an “alarm on” position enables the alarm. When the alarm is enabled, a suitable icon, such as “(((o)))”, will be on. If the snooze function is enabled, a suitable snooze icon, such as “Zz”, will be turned on as well.

A typical snooze function operates as follows. As an example, one minute alarm sounds may be provided at five minute intervals for a set number of times, for example four times. At these intervals, the back lighting will be turned on for 10 seconds, for example. During a snooze period, the icon “Zz” flashes. The snooze function typically is stops only by moving the alarm control out of the snooze position. Each time the stop/light control is engaged when the alarm is beeping, the alarm sound can be stopped immediately with back lighting delaying for about 3 seconds. In this example, the alarm will repeat once again after 5 minutes.

With further reference to the alarm setting capabilities of an illustrated embodiment, “alarm on” can be selected. When the alarm time is reached, an alarm beep will sound for 1 minute, and the back lighting will be illuminated for about 10 seconds. Engaging the stop/light control may stop the alarm. The alarm sound will stop immediately, while the back lighting is delayed for a designated time, such as 3 seconds.

Temperature is displayed, such as in the LCD display, preferably in all operation modes. Typical operation is as follows. A typical arrangement will have a defined temperature range. If the environmental temperature be below the lower limit of this range, appropriate indicia will be displayed, such as “Lo”. Similarly, if the upper limit of the temperature range is exceeded, a display such as “Hi” will appear.

Referring more particularly to the night light mode of operation, a specific example now will be given. Night light time ranges of automatic illumination are available. They are 10:00 p.m. to 6:00 a.m., 11:00 p.m. to 7:00 a.m. and 12:00 a.m. to 8:00 a.m., for example. Upon power activation, the night light time typically is disabled. To specify a night light initial illumination time, the night light mode is selected as desired. In the illustrated example, after selecting the desired night light time period, engaging and holding the night light control for 2 seconds confirms the setting and moves the device out of the night light setting mode.

In an embodiment of the invention, a color of the back lighting will change according to desired parameters. For example, one parameter can be temperature. In a specific example, if the temperature is below 62° F., a color that indicates cool will be displayed, for example, blue. In this arrangement, a temperature between 63° F. and 75° F. will have an illumination color to indicate a comfortable temperature, for example, green. A temperature of 76° F. and above will have an illumination color to indicate warmth, for example, amber.

An example of another typical parameter is time of the day. As an example, the color green may be used to indicate morning, such as between 6:00 a.m. and 11:59 a.m. The color amber may indicate daytime, such as between noon and 5:59 p.m. The color blue may indicate night time, such as between 6:00 p.m. and 5:59 a.m.

Other parameters, other color designations, other temperature thresholds, and other time brackets can be chosen. These choices can be made to satisfy particular needs, desires, tastes, lifestyles, and so forth.

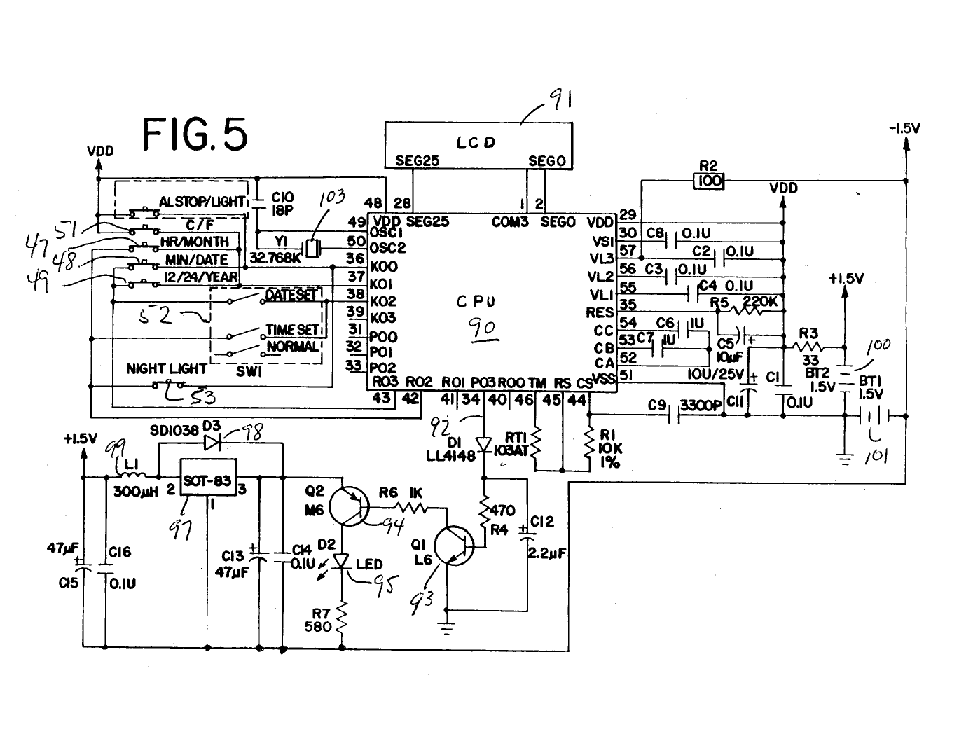

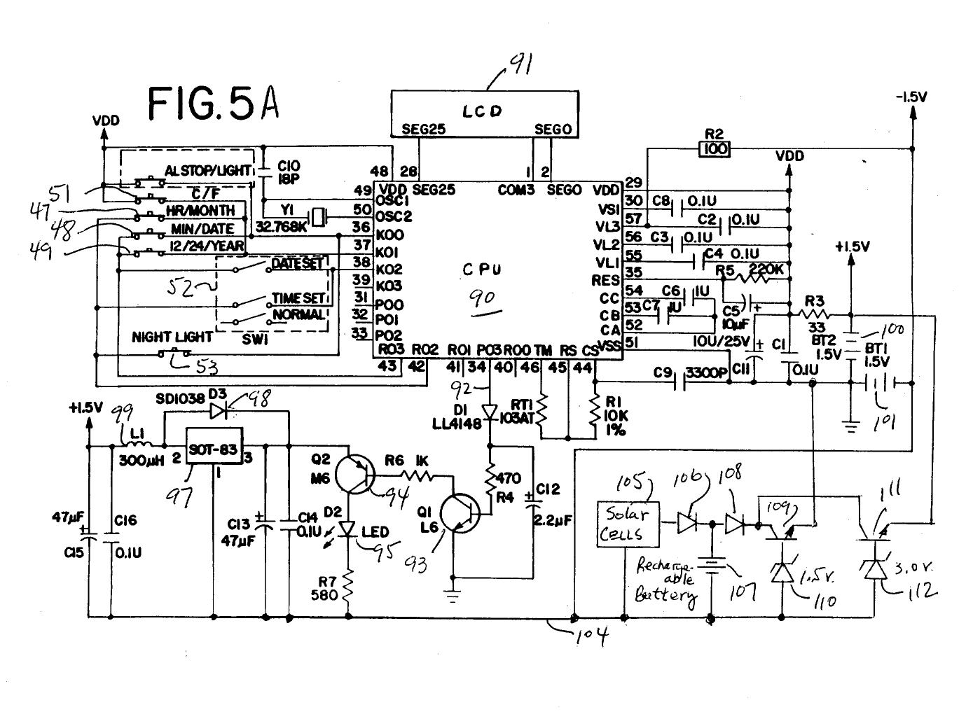

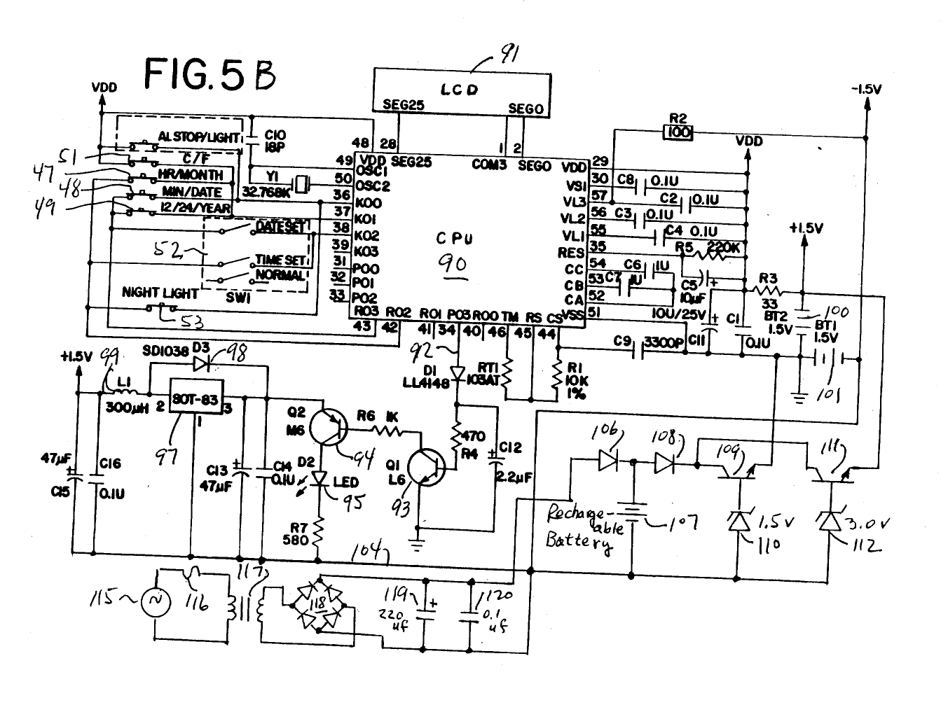

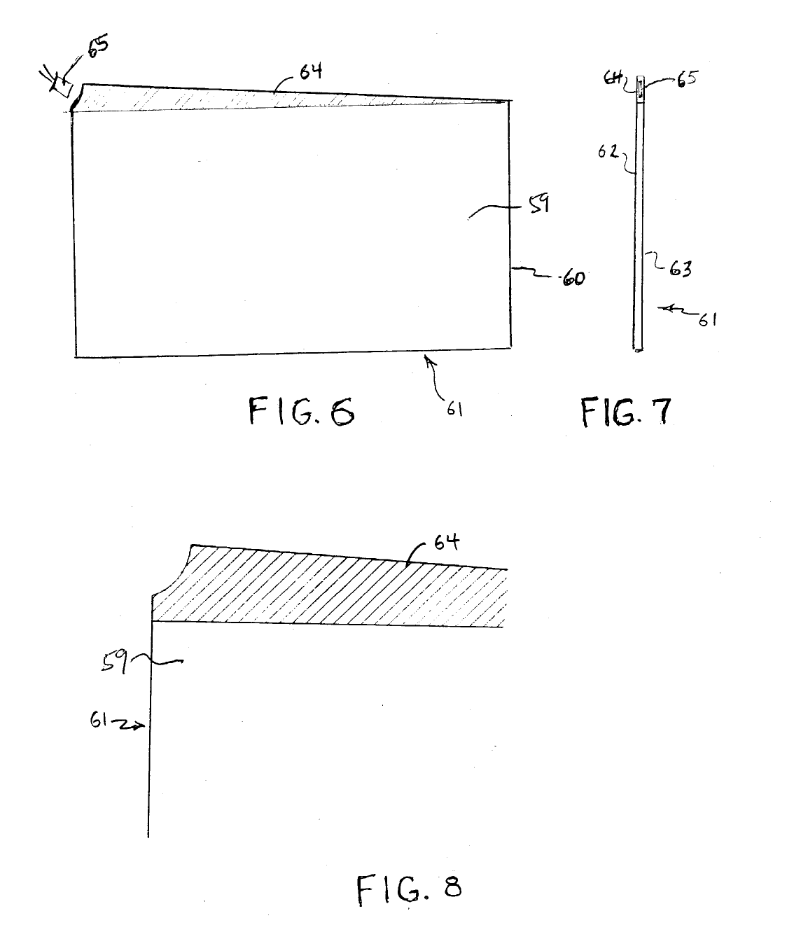

FIG. 5 illustrates an electrical schematic diagram for a clock, such as clock 31 in FIGS. 1-3, in accordance with the present invention. A central processing unit (CPU) 90, which may alternately referred to as a microprocessor or microcontroller, interacts with numerous components in accordance with the setting and operation of a plurality of control switches, such as switches 47-49 and 51-53, as described above. Included are interactions with an LCD display 91, including the time, day and temperature areas 35-37 already described with reference to FIG. 2 and with at least one light source, such as LED 93, for the reflector modules that will be discussed below in reference to FIGS. 6-24.

The electronic circuitry shown in FIG. 5 may operate from a pair of 1.5 volt batteries 100 and 101, which are preferably of the longer lasting alkaline type. A crystal 103 sets the clock frequency for the CPU 90. CPU 90 activates the light source, LED 95, by providing a logic high signal on line 92 to provide base drive to NPN transistor 93, which in turn provides base drive to PNP transistor 94. Transistor 94 then turns on, thereby providing current to LED 95 and causing LED 95 to illuminate. Surge or transient protection is provided in the form of an inductor 99, a surge protection device 97 and a diode 98 to isolate any switching transients created when transistor 94 activates or deactivates LED 95. Thus, the power to CPU 90 is filtered from the switching of LED 95. It will be appreciated that CPU 90 can also accommodate more than one LED 95 on its other unused output terminals. Additional LEDs, similar to LED 95 can be implemented by additional circuitry similar to transistors 93 and 95.

The electronic circuitry of FIG. 5A is similar to the circuitry of FIG. 5 except for the addition of additional power supply circuitry. In this embodiment, one or more solar cells 105 charge a rechargeable battery 107 through a diode 106 that prevents discharge of the battery 107. The reference line 104 is biased at −1.5 volts by the negative terminal of battery 101. Thus, depending upon whether solar power is available, solar cells 105 or rechargeable battery 107 may provide power to the electronic circuitry via transistor 111 to the +1.5 volt level. Transistor 109 with a 1.5 volt Zener diode in its base circuit and which has its emitter referenced to ground, keeps rechargeable battery 107 from being overcharged. This electronic circuitry may not require the more conventional 1.5 volt battery.

The electronic circuitry of FIG. 5B is also similar to the circuitry of FIGS. 5 and 5A except for the addition of alternate power supply circuitry. In this embodiment, an AC power supply 115, such as about 120 volts AC, is used in combination with a rechargeable battery 107 to supply power to the circuitry. A fuse 116 limits current to a transformer 117. The secondary winding of transformer 117 is connected across one side of a full-wave rectifying diode bridge 118 to supply a lower level DC voltage across a pair of capacitors 119 and 120. Capacitors 119 and 120 and rechargeable battery 107 are referenced to the −1.5 volt potential of battery 101. If the AC power source 115 is available, the circuitry will operate from the AC power source. If not, the circuitry will operate from rechargeable battery 107 until the AC power source is again available to replenish the charge on rechargeable battery 107.

The present invention also embodies LED light sources as embodied in reflector module technology that gives a very evenly diffused back lighting effect for an LCD display, including large size LCD displays. Details, options and embodiments in this regard are found in FIG. 6 through FIG. 26. Single, changing or multiple back lighting colors for the LCD display can be achieved. For example, different LEDs can be provided for illuminating different back lighting colors for the LCD display. These may be according to a change in a parameter as generally discussed herein. These can be controlled or programmed as desired so the back lighting color will change from one color to another. This can be done abruptly or gradually to provide a fading out and/or a coming up rhythm. A quartz analogue can be used as well.

Referring to the illustrated LED reflector module, the module includes a reflector of translucent or transparent polymer. A preferred reflector has multiple raised surfaces, points, bumps, protuberances, or the like so that the light waves of the light source travel, spread, diffuse and/or reflect evenly throughout the reflector from corner-to-corner, edge-to-edge and end-to-end.

FIG. 6 shows a lighting assembly or reflector module, generally designated 61 that can be incorporated into the clock 31 of FIGS. 1-3 in accordance with the present invention. This structure is particularly suitable for a larger display surface, which is generally defined as having a perimeter side dimension of about 100 mm or greater. For example, in FIG. 6, the shortest perimeter edge 60 is 96.5 mm. Such larger sizes require higher intensity light sources and excellent reflector design.

With further reference to reflector module design, a front face 62 in FIG. 7 of reflector module 61 has a glossy finish. Also as seen in FIG. 7, reflector module 61 is of generally uniform thickness. A rear face 63 may have a rough or irregular surface, such as a dot engraved surface. A generally wedge-shaped or tapered light channel 64 assists in the excellent diffusion and reflection of light from achieved by this reflector module. It will be appreciated that the rectangular portion 59 of the reflector module 61 operates to illuminate the LCD display. The wedge-shaped channel 64 is typically outside of the back lighting area for the LCD display and assists in dispersing light from LED 65 throughout the reflector module 61. Preferably, the sides of channel 64 are coated with a light reflecting and generally opaque material, such as white paint, a reflective metallic coating or a reflective sticker, or the like, for maximum light reflection in channel 64. All edges of reflector module 61 are also similarly painted or coated, except the curved edge portion 66 that LED 65 transmits light through. In a preferred arrangement, an LED light source, such as LED 65, is positioned near a curved surface 66 of this wedge-shaped light channel to provide light into reflector module 61. LED 65 is also preferably centered with the thickness of the reflector module 61, as seen in FIG. 7, for maximum light dispersion. This arrangement thus illustrated in FIGS. 6, 7, 8, 9 and 10 allows for light from an LED 65 to be diffused evenly throughout the reflector module 61. Maximum light dispersion from the reflector module 61 through the LCD display and into the room in which the clock 31 is located is also desired to provide a night light function.

With this approach, for example, the light at the upper left corner of the module will be as bright as the light intensity in the lower right corner of the module. This even diffusion of light includes having the LED in the upper left corner at the widest portion of the wedge channel 64. Light travels therethrough and through the module 61. Because the light must travel to the farthest point of the module, for example, to the lower right corner in the embodiment illustrated in FIG. 6, the finished portion of the wedge channel is above this location such that the light waves that must travel the farthest have a shorter vertical distance to travel. The dot engraving of the rear face 63 substantially assists in even dispersion of the light during illumination. The wedge shape and the dot-engraving pattern cooperate to evenly diffuse the light throughout the reflector module 61 irrespective of distance from the light source 65. With this arrangement, the light intensity in the lower right corner is as bright as the light intensity in the upper left corner. In other words, all of the dots in the dot array have approximately the same light intensity when the light source or the LED is on.

In an important aspect of various embodiments of the reflector modules according to the invention, the light source is positioned along an edge of the back lighting module. In this arrangement, the light source 65 directs its illumination from the edge, i.e. within the depth, of the module. This is perhaps best illustrated in FIG. 7. Directing the light in this edgewise fashion over the entire surface of the reflector module, especially along the dot engraved rear face 63, as shown in FIGS. 9 and 10, assists in achieving uniform light dispersion that is characteristic of the present invention. Also as shown in FIGS. 9 and 10, the dot matrix pattern may vary in size from one side to the other side, with smaller dots gradually becoming larger dots. This dot size gradient may further assist in achieving uniform back lighting from reflector module 61.

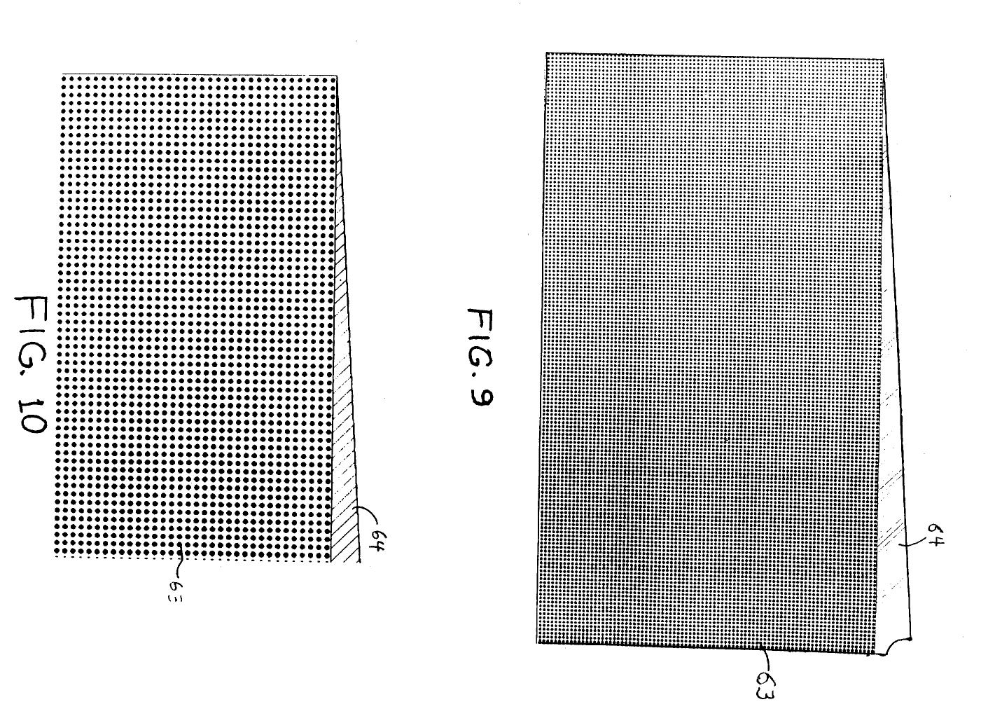

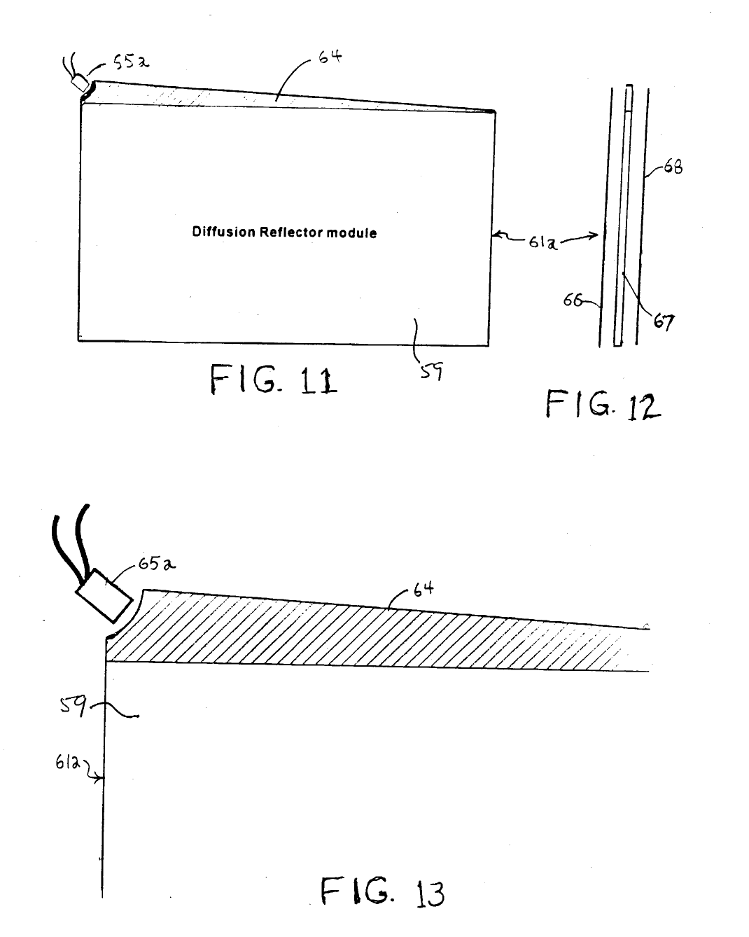

FIG. 11, FIG. 12 and FIG. 13 illustrate an alternative embodiment of back lighting for a suitable diffusion reflector module, generally designated by reference numeral 61a. FIG. 12 provides an exploded view showing a first layer 66 of a diffusion film, which may be milky or translucent in nature, to further assist in more uniform light dispersion. A second layer 67 of a relatively clear acrylic reflector material is provided. A third layer 68 of white plastic paper is disposed at the rear of the module.

A number of alternatives exist to providing an engraved pattern, such as a dot pattern on the back surface of the second layer 76 in FIG. 12. The back side of reflector 61a in FIG. 12 could, for example, be engraved to provide multiple raised surfaces, such as points, bumps, protuberances, or the like. Such rough surfaces result in increased dispersion of light from the reflector module 61a of the clock 31 to provide a more efficient night light capability. Use of engraving techniques can also provide useful light dispersion, including textures, decorative designs, decorative patterns, or the like. If a plastic sheet material or a metal foil is used on the back side of reflector 61a, such sheet materials or foils may also be embossed with textures, designs or patterns for maximum light dispersion.

Light source 65a may be a super bright LED that is positioned to focus down the wedge-shaped light channel 64. More specifically, the illustrated embodiment in FIG. 13 directs the light toward the lower right corner of the diffusion reflector module from the upper left corner. This, in combination with the structural features described herein, has been found to provide excellent diffusion reflector back lighting for a LCD display. This lighting is very suitable for operation of the clock 31 as a night light.

The second layer 67 of reflector module 61a is an acrylic layer that has raised surface engraving, which may be in the form of dots, on its rear face. The front face of this second layer has a glossy finish. Light travels and is reflected throughout the diffusion module and will escape the front face, but not the rear face.

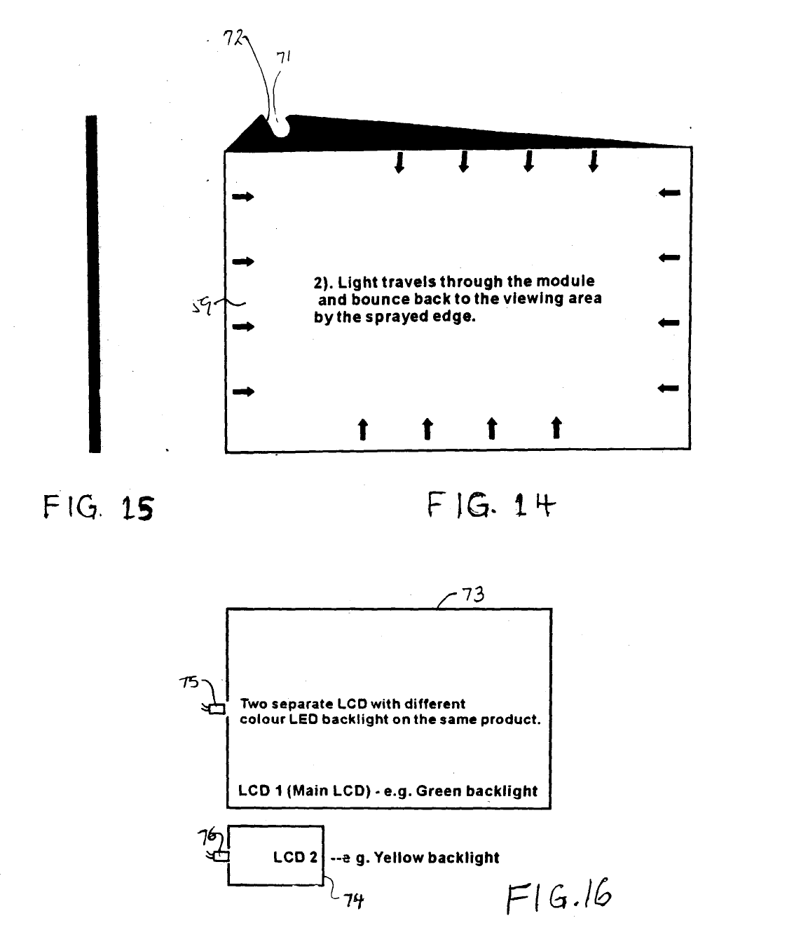

Further embodiments of diffusion reflector modules of this type are illustrated in FIG. 14 and FIG. 15. Generally, these Figures show a highly reflective edge that assists in having the light bounce back and out of the viewing area through the LCD display. This can be achieved, for example, by spraying the perimeter edge with a reflective material or pigment that is perpendicular to the viewing surface of FIG. 14 and is generally shown in FIG. 15. These perimeter surfaces are preferably sprayed with white paint to provide advantageous reflective properties.

A light source area 71 is provided in a portion of the edge, such as in the form of a notch or recess, as shown in FIG. 14. The edge 72 within this notch or recess is clear such that light emitted from the LED is gathered and transmitted in and throughout the reflector module. It is important to note that only the light source area edge is clear and thus substantially non-reflective. All other edge surfaces are painted with reflective as illustrated by the arrow markers in FIG. 14.

Among the options for the clock properties, the parameters of temperature and of time can each have their own separate LED diffusion module for use as a color indicator, for example. Thus, there can be two totally independent LED diffusion modules. These modules can be positioned as desired with respect to each other, such as at desired locations on a face of the casing 32.

Yet another embodiment in FIG. 16 illustrates independent LED light sources for separate LCD displays. A first LCD display 73 has its own light source 75. This light source may be, for example, an LED that emits a color of light that is indicated as being distinctive for the particular parameter, such as green. This parameter could be a time or a date parameter, for example. A second LCD display 74 is physically separate from that of the first LCD display 73, including separate reflector modules for back lighting the LCD displays 73 and 74. Second LCD display 74 has its own light source 76 for back lighting. Typically, this will provide a light source different in color from that of light source 75. In the illustrated example, this may be an LED light source that provides yellow coloration and thus a yellow back light for LCD display 74. Preferably, each display embodies the diffusion reflector module back lighting features as disclosed herein.

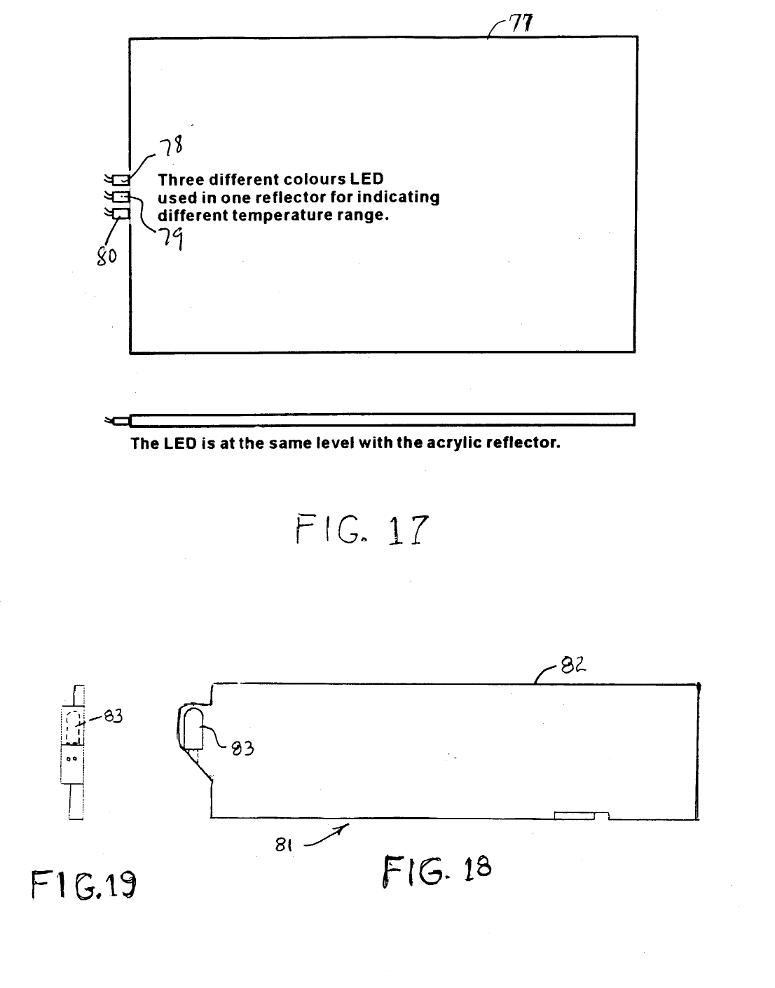

FIG. 17 illustrates still another embodiment where a single reflector module 77 in accordance with the present invention provides the reflector module with a plurality of light sources in the form of different color LEDs 78-80. The different colors can indicate different temperature ranges or different periods of the day or night, for example. This particular embodiment has three LEDs each having a different color. Each LED is positioned along the edge, such as along a side edge of the acrylic reflector component of this reflector module.

The reflector module 77 of FIG. 17 allows one to provide special effects, including automatic color change. Software such as may be utilized by CPU 90 in FIGS. 5, 5A and 5B can arrange for automatic color change according to a desired aesthetic or environmental effect. An example of a color combination sequence in this regard could include the sequence of blue light, followed by green light, followed by yellow light, and followed by blue light, and so forth. Illumination timing may be varied as desired.

Generally, for a smaller area module, a light source that is less intense or bright than the LED sources disclosed herein can be used. This can be accommodated in modules where none of the perimeter sides has a length greater than about 100 mm. A lower intensity light source can be, for example, a relatively small light bulb. An example of a diffusion reflector module of this type is shown in FIGS. 18 and 19. This reflector module 81 has a longest perimeter edge 82 of 99 mm.

Overall, the structure of this module is as described herein in connection with modules incorporating one or more LED light sources. Light source 83 is a relatively small light bulb. This side-mounted light source continues to direct its light from an edge orientation, with exceptional diffusion features and reflection features. The light emanating from light source 83 enters the module from a side edge and preferably reflects off the remaining perimeter edges of the module. This particular module shape is useful for fitting within a clock casing having particular structural features.

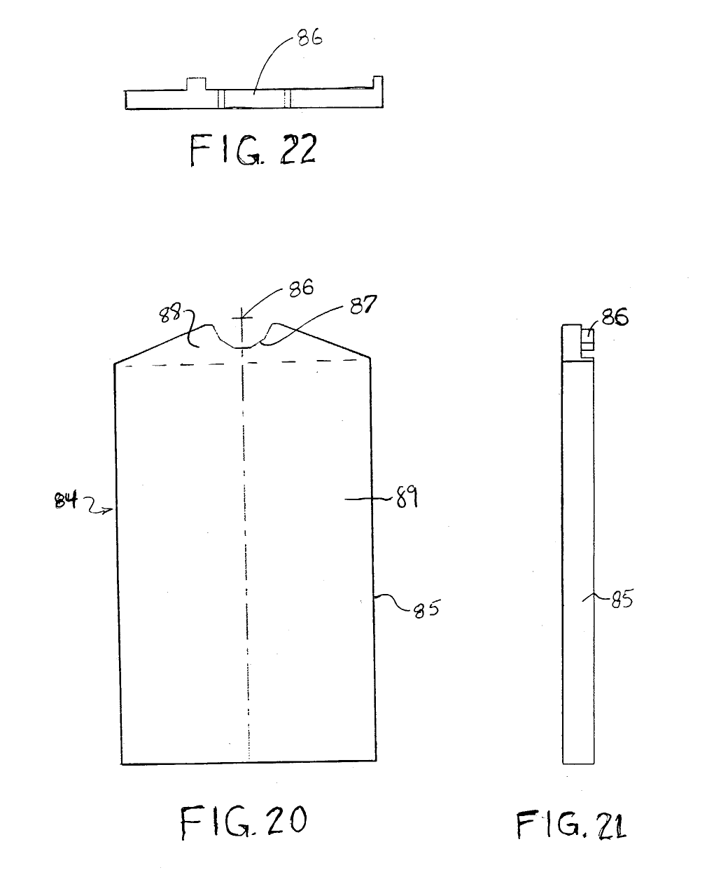

Another reflector module 84 is shown in FIG. 20, FIG. 21 and FIG. 22. Reflector module 84 is also a smaller reflector module that has a longest perimeter side 85 of 72 mm in length. This side edge 85 is shown in FIG. 21. This particular design has a light source area 86 to accommodate a small light bulb, LED, or the like. Preferably, this light source for this reflector module has its light beams pass through a transparent area 87 and into the interior of the module that has reflective edges along the remainder of the module, as generally discussed hereinabove with respect to other reflector modules.

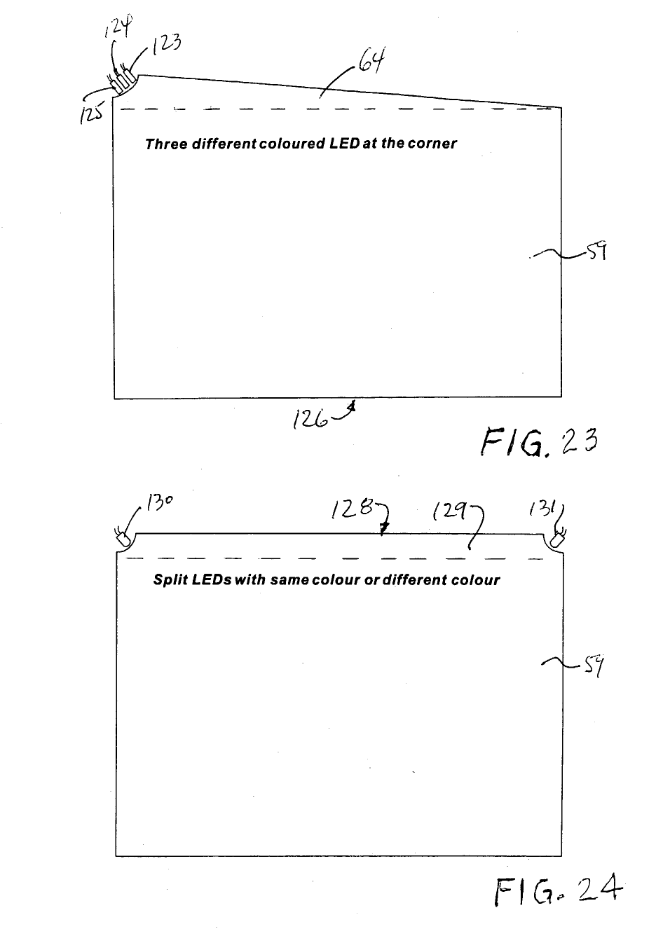

FIG. 23 illustrates yet another reflector module 126. Reflector module 126 has a generally rectangular and clear front surface 59 with a painted or coated reflective wedge area 64. This embodiment utilizes three LEDs 123-125 of different colors disposed in a notch in an upper corner of reflector module 126 to provide different colors or mixtures of colors. For example, if two of LEDs 123-125 are red and yellow, simultaneous activation of these red and yellow LEDs will provide an orange color.

Another reflector module 128 is illustrated in FIG. 24. In this embodiment, the reflective wedge 64 used in other embodiments, is instead a rectangular reflector 129. Two LEDs, are disposed in opposite corners, such as LED 130 in the upper left corner and LED 131 in the upper right corner. LEDs 130 and 131 may be activated separately or simultaneously, as desired. LEDs 130 may be the same color or different colors.

FIG. 25 illustrates a further embodiment of a reflector module 133. This embodiment resembles the embodiment in FIG. 9, except that the LED 134 is disposed in an upper left corner instead of an upper right corner. In this respect, LED 134 is disposed closer to the dot matrix pattern of smaller dots, rather than adjacent to the larger dots as in FIG. 9.

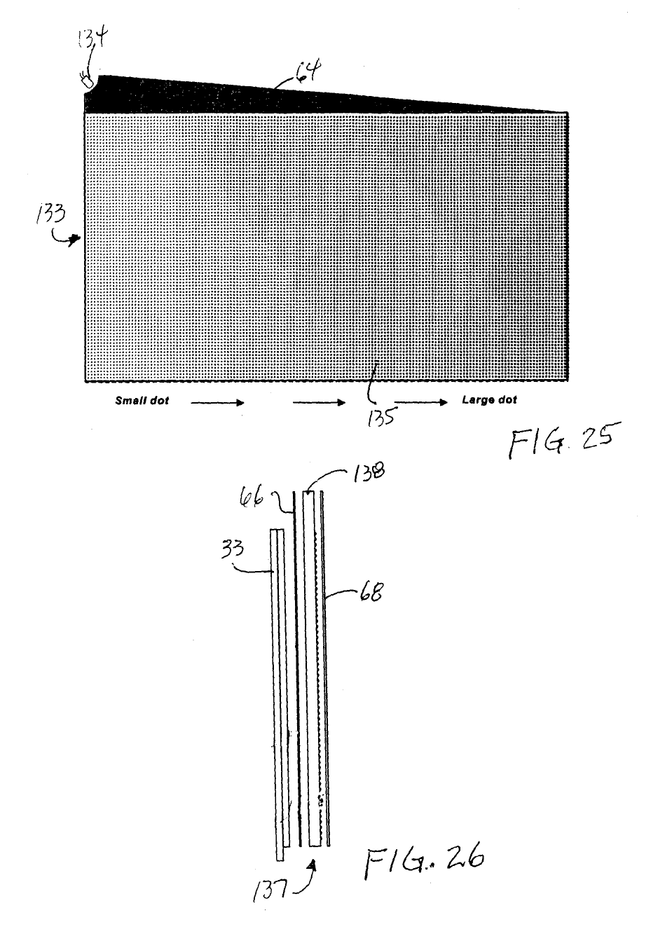

FIG. 26 illustrates an alternate embodiment of a reflector module 137 from that previously discussed with reference to FIG. 12. In this embodiment, a reflector module 137 is disposed behind a LCD display 33 to provide back lighting for the display. A diffusion film 66 may optionally be provided between LCD display and reflector module 137. An acrylic reflector element 138 may be provided with a dot pattern matrix on its back surface, or any other diffusion mechanism, such as an engraved pattern, or the like. A back reflective layer, such as a white plastic sheet material, or the like, assists in reflecting dispersed light through the LCD display 33 to illuminate the same.

Concerning options for coloration variations, it is possible to have multiple separate LEDs of different back light colors on the same device. For example, a first LCD display could have a back lighting color A for showing time. Another LCD display, for example one that is smaller than the former LCD display, can have a back lighting color B to show alarm time. Another example is for a main LCD display to have a back lighting color A for showing time, with a smaller LCD display having a back lighting color B for showing temperature. These back lighting colors are quite suitable for also providing the night light feature discussed herein and can be activated and deactivated according to desired time sequences.

Clock devices according to the invention can be DC powered or AC powered. Typically, the former will, because of battery drain constraints, have a night light display time limited to, for example, 6 or 7 hours during each night or each sleeping period. An AC powered version is more likely to be suitable for having an LED night light feature that may be continuously on or one that more easily accommodates illumination time periods of greater than about 7 hours.

It will be understood that the embodiments of the present invention that have been described are illustrative of some of the applications of the principles of the present invention. Various modifications may be made by those skilled in the art without departing from the true spirit and scope of the invention.

1. A reflector module for back lighting of a liquid crystal display of a clock, said liquid crystal display having a defined area, said reflector module comprising:
a generally clear module element having edge surfaces and sized to be disposed in back of said liquid crystal display;
said edge surfaces having light reflective properties to substantially reflect light about the interior of said clear module element;
a portion of said clear module element extending beyond the defined area of said liquid crystal display; and
a light source disposed at a point along an edge of said portion of the generally clear module element that extends beyond the defined area of said liquid crystal display to provide light into said reflector module.

2. The reflector module as claimed in accordance with claim 1 wherein the light source comprises one or more light emitting diodes.

3. The reflector module as claimed in accordance with claim 1 wherein said portion of the generally clear module element extending beyond the defined area of said liquid crystal display has sides with reflective properties.

4. The reflector module as claimed in accordance with claim 1 wherein the power for said light source is selected from the group consisting of conventional battery power, rechargeable battery power, solar cells or an alternating current power source.

5. The reflector module as claimed in accordance with claim 1 wherein a diffusion film is disposed between said liquid crystal display and said generally clear module element.

6. The reflector module as claimed in accordance with claim 1 wherein said generally clear module element is engraved on its rear surface.

7. The reflector module as claimed in accordance with claim 6 wherein the engraving on the rear surface of the generally clear module element comprises a dot matrix pattern.

8. The reflector module as claimed in accordance with claim 7 wherein said dot matrix pattern has a gradient of smaller dots to larger dots in one direction across said generally clear module element.

9. The reflector module as claimed in accordance with claim 1 wherein said point along the portion of the module element that extends beyond the area of the liquid crystal display comprises a recess or notch for receiving the light source.

10. The reflector module as claimed in accordance with
claim 9 wherein said notch or recess does not have said light reflecting properties such that a significant portion of the light transmitted by said light source is gathered by the module element.

11. The reflector module as claimed in accordance with claim 1 further comprising a light reflective material disposed behind said module element.

12. The reflector module as claimed in accordance with claim 1 wherein said light source is disposed along an edge of said module element.

13. The reflector module in accordance with claim 1 further comprising an additional module element for back lighting of an additional liquid crystal display.

14. The reflector module as claimed in accordance with claim 13 wherein said additional module element has a light source of a different color than the other light source.

15. The reflector module as claimed in accordance with claim 1 wherein said module element has a plurality of light sources disposed therealong with at least two of the light sources being of different colors.

16. A clock with a liquid crystal display for displaying multiple indicia, said liquid crystal display having a defined area, said clock comprising:
a reflector module for back lighting of the liquid crystal display of said clock;
said reflector module including a generally clear module element having edge surfaces and sized to be disposed in back of said liquid crystal display, said edge surfaces having light reflective properties to substantially reflect light about the interior of said clear module element, a portion of said clear module element extending beyond the defined area of said liquid crystal display; and
a light source disposed at a point along an edge of said portion of the generally clear module element that extends beyond the defined area of said liquid crystal display to provide light into said reflector module.

17. The clock with a liquid crystal display as claimed in accordance with claim 16 wherein the light source comprises one or more light emitting diodes.

18. The clock with a liquid crystal display as claimed in accordance with claim 16 wherein said portion of the generally clear module element extending beyond the defined area of said liquid crystal display has sides with reflective properties.

19. The clock with a liquid crystal display as claimed in accordance with claim 16 wherein the power for said light source is selected from the group consisting of conventional battery power, rechargeable battery power, solar cells or an alternating current power source.

20. The clock with a liquid crystal display as claimed in accordance with claim 16 wherein a diffusion film is disposed between said liquid crystal display and said generally clear module element.

21. The clock with a liquid crystal display as claimed in accordance with claim 16 wherein said generally clear module element is engraved on its rear surface.

22. The clock with a liquid crystal display as claimed in accordance with claim 21 wherein the engraving on the rear surface of the generally clear module element comprises a dot matrix pattern.

23. The clock with a liquid crystal display as claimed in accordance with claim 22 wherein said dot matrix pattern has a gradient of smaller dots to larger dots in one direction across said generally clear module element.

24. The clock with a liquid crystal display as claimed in accordance with claim 16 wherein said point along the portion of the module element that extends beyond the area of the liquid crystal display comprises a recess or notch for receiving the light source.

25. The clock with a liquid crystal display as claimed in accordance with
claim 24 wherein said notch or recess does not have said light reflecting properties such that a significant portion of the light transmitted by said light source is gathered by the module element.

26. The clock with a liquid crystal display as claimed in accordance with claim 16 further comprising a light reflective material disposed behind said module element.

27. The clock with a liquid crystal display as claimed in accordance with claim 16 wherein said light source is disposed along an edge of said module element.

28. The clock with a liquid crystal display as claimed in accordance with claim 16 further comprising an additional module element for back lighting of an additional liquid crystal display.

29. The clock with a liquid crystal display as claimed in accordance with claim 28 wherein said additional module element has a light source of a different color than the other light source.

30. The clock with a liquid crystal display as claimed in accordance with claim 16 wherein said module element has a plurality of light sources disposed therealong with at least two of the light sources being of different colors.

31. The clock with a liquid crystal display as claimed in claim 16 wherein said light source emits sufficient illumination through said liquid crystal display to provide night lighting.

32. The clock with a liquid crystal display as claimed in claim 16 wherein said light source may be programmed to provide a night light function.

33. The clock with a liquid crystal display as claimed in claim 16 wherein said liquid crystal display provides multiple indicia selected from the group consisting of time, day, month, year or temperature.
